(19) United States
(12) Patent Application Publication
(10) Pub. No.: US 2012/0132656 A1
(43) Pub. Date: May 31, 2012

(54) DEVICE FOR STORING GAS UNDER PRESSURE

(75) Inventors: Torgeir Nakken, Porsgrunn (NO); Jan Schelling, Porsgrunn (NO); Leif Kåre Grønstad, Sannidal (NO); Sandra Nilsen, Porsgrunn (NO); Odd Ståle Tveit, Hafrsfjord (NO); Bjømar Werswick, Langesund (NO)

(73) Assignee: NEL Hydrogen AS, Notodden (NO)

(21) Appl. No.: 13/203,708

(22) PCT Filed: Feb. 26, 2010
(86) PCT No.: PCT/NO2010/000076

§ 371 Date: Feb. 8, 2012

(30) Foreign Application Priority Data
Mar. 3, 2009 (NO) 2009 0942

(51) Int. Cl. F17C 1/00; F17C 13/08

(52) U.S. Cl. 220/585

(57) ABSTRACT

The present invention relates to a device for storing gas under pressure comprising an inner cylindrical pressure vessel (1), the pressure vessel (1) comprising pipe connection (7). According to the present invention, the device is characterized in that the inner cylindrical pressure vessel (1) is arranged inside an outer vessel (3), whereby a substantially annular space (2) is formed between the inner pressure vessel (1) and the outer vessel (3), wherein the annular space (2) between the inner pressure vessel (1) and the outer vessel (3) is filled with a fluid, the outer vessel (3) further comprising venting means (5) at or in the vicinity of the highest point (4, 6) of the outer vessel (3).

The present invention relates to a storage device/system for storing gas under pressure. The device is especially suitable for storing compressed gaseous hydrogen and can be connected to a hydrogen fuel replenishment system. The invention can also be applied to other gases such as hydrocarbon compounds which are commonly stored for industrial purposes, for vehicle refueling or for heating purposes.

Gaseous hydrogen is typically stored in pressurized cylindrical tanks (pressure vessels) of various sizes. These cylinders are either made of steel or consist of composite material comprising a gas tight liner (typically metal or plastic) and a fibrous wrapper. A storage installation consists typically of several individual vessels, which are interconnected with gas tubing (gas supply tubing as well as gas discharge tubing). The vessels are typically arranged in a rectangular pattern and supported by a metal frame which keeps the vessels in position relative to each other and supports the entire bundle or stack of vessels. The axes of the vessels are oriented either horizontally (in one or more stacks) or vertically (in one or more bundles).

A storage installation is typically placed outdoors on or above ground level, sometimes housed in a light steel construction or in a more solid concrete construction. Alternatively, the installation can be buried in earth below ground level providing improved protection from external influences such as radiation from adjacent fires or damage caused by explosions. Placing the tanks in the ground can be space-saving, especially in urban areas (i.e. filling stations). This alternative is rarely used as it makes inspection of the vessels and interconnecting piping very difficult and requires expensive measures to prevent corrosion (such as for example coating of the external tank surface and/or installation of a sacrificial anode for cathodic protection.

Leak detection, especially in combination with uncovered outdoor installations, is a major challenge as small leaks quickly become diluted and are difficult to locate. Other known underground installations will allow gas leaks to penetrate uncontrolled through the top of the basin thus posing an inherent risk and making leak detection more difficult.

To overcome the difficulties related to inspection of buried vessels while maintaining the safety features a system for storage of liquid or gaseous hydrocarbon compounds has been proposed in NL-C-1001796. The vessels are submerged in a basin filled with a liquid, for example water. Thus the vessels are protected from external influences such as fires and explosions while the vessel can be easily inspected by lowering the water level in the basin. Optionally the top of the basin can be covered with wood, steel or concrete elements.

Said system however, makes gas leak detection difficult. Said system will allow gas leaks to penetrate uncontrolled through the top of the basin, thus posing an inherent risk of undetected explosive gas mixtures.

WO 2006/088378 A1, filed by the present applicant, describes a plant comprising at least one basin filled with a liquid, one or more pressure vessels located in said basin for storing said gas including interconnecting piping and connections to a gas supply and a gas discharge network, an anchoring system for supporting said vessels, a cover with a slanted surface on the underside 6 for covering said basin which will lead any gas leak occurring in said basin towards and through a vent, and at least one gas detection equipment located in said vent.

WO 2006/088378 A1 provides a plant for storing gas under pressure which allows early detection of very small gas leaks, which improves the safety of the plant beyond the previously described underground storage system, which requires less area than conventional installation as most of the cover area can be used for other purposes, and which will result in a more even storage temperature for the gas.

The aim of the present invention is to provide further improved techniques for storing gas, especially in regard to safety, early leak detection, cost savings and simplified maintenance.

According to the present invention, these and other aims are reached by a gas storage device/system according to the characterizing clause of independent claim 1. Further advantageous embodiments and features are described in the dependent claims.

The gas storage system according to the present invention comprises a tank-in-tank configuration wherein an inner tank is arranged to hold the gas and wherein an outer tank is arranged to provide a fluid filled annulus. This configuration provides a number of advantages over the solution provided given in WO 2006/088378 A1:
the outer tank and the fluid filled annulus provide additional safety barriers,
the volume of liquid required is minimized (lower cost, improved temperature control, reduced environmental risk),
accessibility for inspection and maintenance is further improved,
total storage divided into smaller sub-modules improves safety,
modular design allows greater flexibility while using standardized design elements.

The present invention will now be described by way of example and with reference to the accompanying drawings in which:

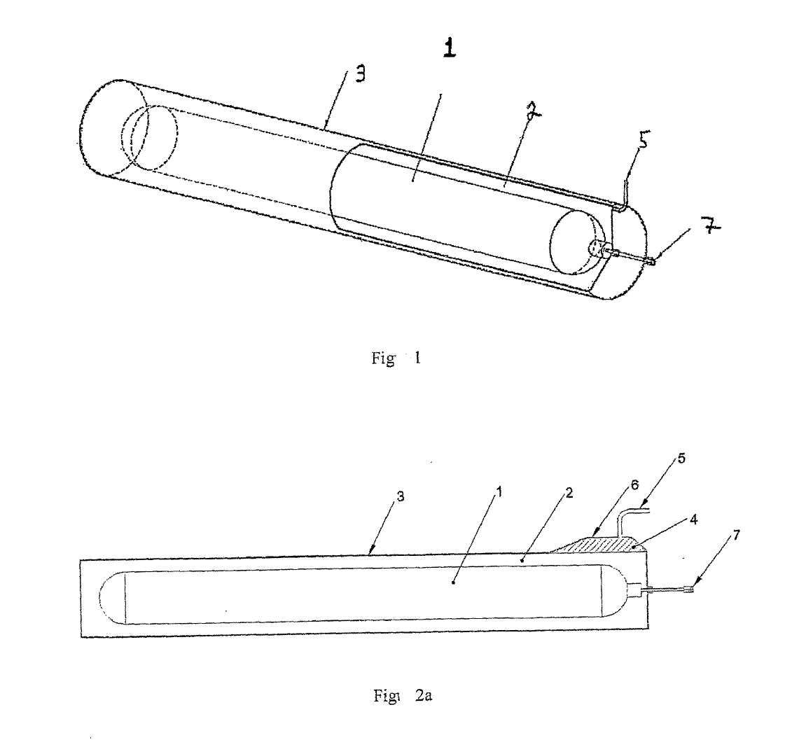

FIG. 1 is a plan view illustrating one embodiment of the present invention,

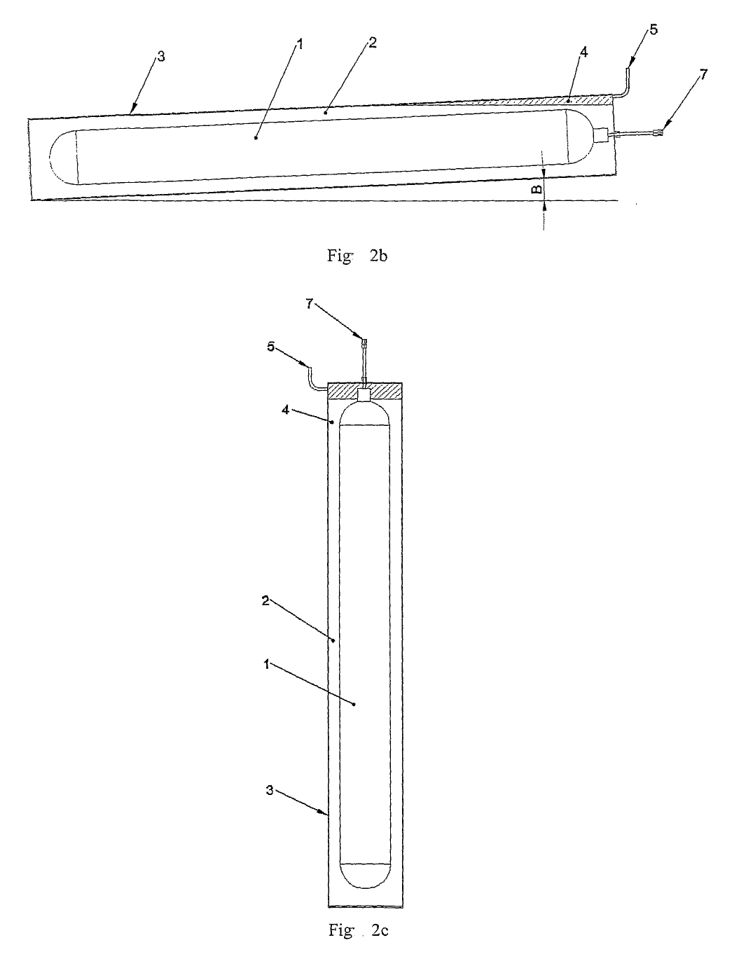

FIG. 2a is a plan view illustrating another embodiment of the present invention, comprising a “bulge”,

FIG. 2b is a plan view illustrating another embodiment of the present invention, comprising an angled arrangement,

FIG. 2c is a plan view illustrating another embodiment of the present invention, comprising a standing arrangement,

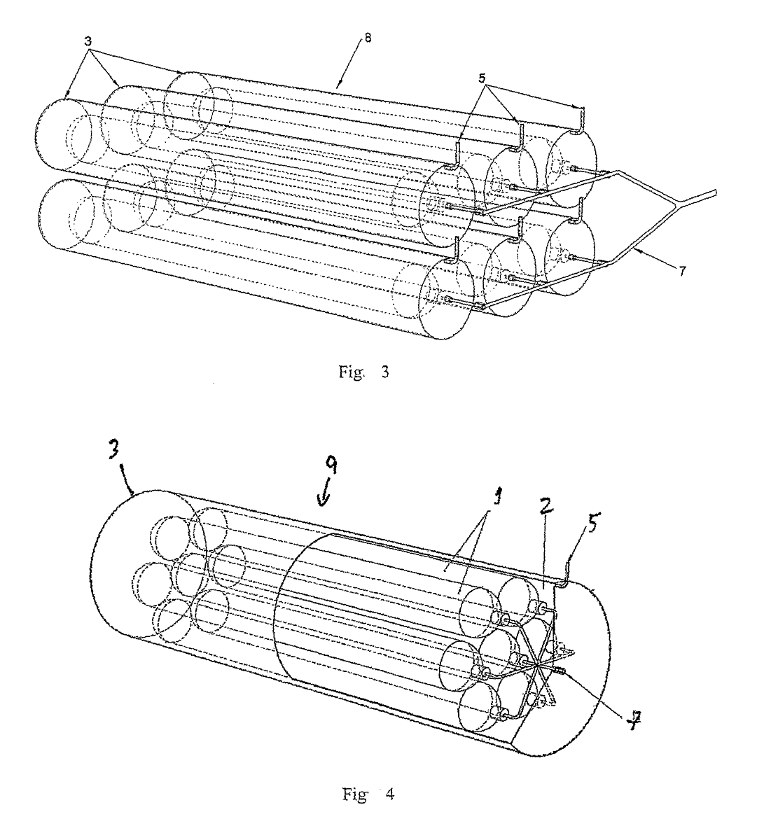

FIG. 3 is a plan view illustrating a bank embodiment, and

FIG. 4 is a plan view illustrating another bank embodiment.

Referring now to FIG. 1, a pressurized tank 1 is contained inside a surrounding tank 3 in a tank-in-tank configuration. An annular or surrounding space 2 is provided between the pressurized tank 1 and surrounding tank 3, and this annular or surrounding space 2 is filled with a suitable fluid. The fluid may be water, glycol, or any other suitable fluid with appropriate properties, such as inertness, stability, ability to absorb gas etc. The fluid may also be provided with appropriate compounds or additives, permitting the fluid to change color, increase or decrease its conductivity or other properties that may possibly aid a gas detection means in detecting gas leaks.

As only the annulus or space 2 between the inner and outer tank according to the present invention is filled with fluid, contact between escaping flammable gas and air or some other gas, may only occur in a predefined venting area 4 that may be equipped with a venting pipe 5 and gas detection means. This greatly reduces the risk of undetected explosive gas mixtures, and makes it easy to locate a leaking container in configurations comprising two or more individual tanks.

Each tank comprises a connecting piece 7 that runs from the pressurized tank 1, though the surrounding space 2 and the surrounding tank 3. This connecting piece 7 is used to fill the tank with pressurized gas and thereafter to tap off gas according to need.

This tank-in-tank configuration efficiently protects each storage vessel from external influences such as radiation from adjacent fires, impact from external explosions or collisions involving vehicles and or other moving objects.

According to one embodiment of the present invention, one or more individual tanks and/or banks of tanks, each individual tank comprising a tank-in-tank configuration, are located in a below ground installation. In case of an explosion or acceleration of gas containing equipment due to the thrust caused by a large leak, the extent of damage inflicted on nearby buildings, equipment and human beings is greatly reduced compared to an above ground installation as the horizontal impact is suppressed by the storage room walls and the surrounding earth masses. The area required for a given storage volume of gas is greatly reduced compared to above ground installations.

A further feature of the present invention is the provision of a gas collection space/point and venting system inside the annular space between the inner and outer tanks of the tank-in-tank configuration. The contained gas will be lighter than the fluid contained in the annulus between the tanks, and in the event of a leak, the escaping gas will migrate to the highest point 4 inside the annulus. By either providing a “bulge” or a collection chamber 6 somewhere near this highest point 4 inside the annulus 2 of a horizontally positioned tank (FIG. 2a), slanting the tank slightly (FIG. 2b) with an angle B, or even raising the tank to an upright position (FIG. 2c), whereby leaking gas will migrate through the fluid and collect at this highest point 4. If the tank is arranged in a horizontal position, the collection chamber 6 may be arranged anywhere in the vicinity of the top of the surrounding tank 3. A venting arrangement 5 is provided at this gas collection point 4, preferably in combination with a gas detection device provided somewhere along the venting arrangement 5. By providing a gas detection device (not shown) for each individual tank or a bank 8, 9 of tanks, a leak may be detected rapidly and easily, whereby protective measures may be implemented in regard to the individual tank or bank of tanks only without having to shut down all tanks that are stored in a storage facility, e.g. in an underground storage facility.

According to another embodiment of the present invention, an internal or external heat exchanger means (not shown) can be provided to control the temperature of the fluid in the annulus 2, which can be used to efficiently lower the gas temperature, thereby allowing shorter refueling times etc. An “internal” heat exchanger means implies that the heat exchanger means is provided somewhere inside the individual tank, or possibly on the outside, while an “external” refers to heat exchanger means that is more remotely positioned to the individual tank or tanks. In some applications involving the use of more than one individual tank or bank 8, 9 of tanks, it will be a clear advantage to be able to control the temperature of each tank or bank 8, 9 individually.

According to one embodiment of the present invention, the fluid provided in the annular or surrounding space 2 between the pressurized tank 1 and surrounding tank 3, may consist of a gas. This gas may be inert, e.g. N₂. This embodiment would require the use of a semi-permeable membrane (not shown) or the like arranged near the highest point 4, the “bulge” and/or collection chamber 6, the membrane constituting a boundary between the inert gas and the highest point 4, the “bulge” and/or collection chamber 6. The membrane may be chosen according to its ability to block the inert gas, e.g. N₂, from penetrating the membrane in one direction and blocking O₂ and other air gasses the other direction, while permitting the leaking stored pressurized gas through the membrane. A detection means will detect the raised levels of the leaking stored pressurized gas once it has penetrated the membrane and reached the highest point 4, the “bulge” and/or collection chamber 6.

According to the present invention two or more individual tanks may be grouped and connected together, thereby forming a bank 8, 9, see FIG. 3, with the individual tanks maintaining individual venting 5 and detecting systems, or alternatively, the bank 8, 9 of tanks forming an individual unit with a common venting 5 and detection system, see FIG. 4. In this case the connecting pieces 7 are brought together and interconnected, whereas filling and tapping off is conducted for the bank 8, 9 as a whole, acting as one larger tank. One advantage of this configuration is that a larger storage capacity may be obtained by modular similar units, avoiding the need for multiple production lines, varying production methods etc. This enables the construction of sufficiently large storage capacity, while still ensuring that leaks in one of the individual tanks or bank 8, 9 of tanks easily may be detected. This feature is important both in terms of safety and maintenance, as it facilitates the localization of leaks. Once the leak is localized, the leaking tank or bank 8, 9 of tanks may be isolated and repaired, while the rest of the tanks in the common storage facility may still perform its normal function. This eliminates or reduces down time and facilitates maintenance and repair.

The bank 8 of tanks shown in FIG. 3 comprises a number of individual tank-in-tank units that grouped together and form a larger storage tank. The venting 5 and detection systems are arranged individually for each individual tank, while the connecting pieces 7 are interconnected. If a leak is detected in one of the individual tanks, the leaking tank may be isolated and removed without affecting the functionality of the remaining bank of tanks. In due course the leaking tank may be replaced by a fully functional tank, thereby restoring full storage capacity.

The bank 9 of tanks shown in FIG. 4 comprises a number of individual pressurized tanks 1 contained inside one common surrounding tank 3. Both the venting/detection means and the connection pieces 7 are interconnected. If a leak should occur in one of the pressurized tanks 1, this will knock out the entire bank as there is no way to know which of the individual pressurized tanks 1 is experiencing a leak. After isolating the entire bank, the leaking pressurized tank inside the common surrounding tank 3 must be localized and repaired, before the bank 9 is brought online again.

1. Device for storing gas under pressure comprising an inner cylindrical pressure vessel (1), the pressure vessel (1) comprising pipe connection (7), characterized in that the inner cylindrical pressure vessel (1) is arranged inside an outer vessel (3), whereby a substantially annular space (2) is formed between the inner pressure vessel (1) and the outer vessel (3), wherein the annular space (2) between the inner pressure vessel (1) and the outer vessel (3) is filled with a fluid, the outer vessel (3) further comprising venting means (5) at or in the vicinity of the highest point (4, 6) of the outer vessel (3).

2. Device according to claim 1, characterized in that the outer vessel (3) further comprises detection means either at or in the vicinity of the highest point (4, 6) of the outer vessel (3), or in connection with the venting means (5).

3. Device according to claim 1 or 2, characterized in that the device comprises internal or external heat exchanger means.

4. Device according to claim 1, characterized in that the device comprises a gas collection chamber (6) at or in the vicinity of the highest point (4) of the outer vessel (3).

5. Device according to claim 1, characterized in that the device is positioned in an angel (B) relative to the horizontal plane.

6. Device according to claim 5, characterized in that the angel (B) is between 0-90°.

7. Device according to claim 6, characterized in that the angel (B) is between 1-25°.

8. Device according to claim 1, characterized in that the device is positioned in an upright position, i.e. with an angle (B) of 90° relative to the horizontal plane.

9. Device according to any of the previous claims, characterized in that it is arranged together with one or more other similar devices, thereby forming a bank (8, 9), wherein the pipe connection (7) of each device is connected either in parallel, series or a combination thereof, while each device maintains individual venting (5) and/or detection means.

10. Device according to any of the previous claims, characterized in that the fluid comprises a liquid.

11. Device according to any of the previous claims, characterized in that the fluid comprises a gas.

12. Device according to claim 11, characterized in that a semi-permeable membrane or the like is arranged near the highest point (4) and/or collection chamber (6), the membrane constituting a boundary between the inert gas and the highest point (4) and/or collection chamber (6).

13. Device according to claim 12, characterized in that the membrane is chosen according to its ability to block the fluid from penetrating the membrane in one direction and blocking O₂ and other air gasses the other direction, while permitting the leaking stored pressurized gas through the membrane.

14. Device according to any of the previous claims, characterized in that it is positioned at a location in or under the ground, e.g. in an underground storage facility.
